(19) United States
(12) Patent Application Publication
(10) Pub. No.: US 2026/0312796 A1
(43) Pub. Date: Oct. 8, 2026

(54) METHOD AND SYSTEM FOR ERROR CORRECTION IN QUANTUM CRYPTOGRAPHY COMMUNICATION

(71) Applicants: QSIMPLUS CO., LTD., Seoul (KR); Korea University Research and Business Foundation, Seoul (KR)

(72) Inventors: Kwang Seok NOH, Seoul (KR); You Chul SHIN, Hanam-si, Gyeonggi-do (KR); Jun HEO, Seoul (KR)

(21) Appl. No.: 18/996,889

(22) PCT Filed: Jul. 20, 2023
(86) PCT No.: PCT/KR2023/010529

§ 371 Date: Jan. 17, 2025

(30) Foreign Application Priority Data
Jul. 21, 2022 (KR) 10-2022-0090248
Jul. 20, 2023 (KR) 10-2023-0094440

(51) Int. Cl. H04L 9/08; H04L 1/00

(52) U.S. Cl. CPC H04L 9/0858; H04L 1/0061

(57) ABSTRACT

A quantum cryptography communication method between a first communication device and a second communication device may include: a quantum communication step of generating a second information sequence based on a first information sequence by the second communication device, when the first communication device transmits the first information sequence generated by randomly modulating a phase or polarization of photons to the second communication device; and a post-processing step of adjusting the first information sequence and the second information sequence to be identical on the basis of an error correction mode selected based on a predetermined criterion. The error correction mode may be classified according to a subject of decoding parity information.

### TECHNICAL FIELD

The present invention relates to a quantum cryptography communication method and system.

### BACKGROUND ART

Quantum cryptography communication is a technique for preventing hacking by creating quanta that cannot be divided any more using light particles, and then creating and distributing a decryptable encryption key between a sender and a receiver. The quantum cryptography communication is a technique of safely distributing encryption keys between a sender and a receiver through quantum communication, and is also referred to as Quantum Key Distribution (QKD).

Quantum cryptography communication is configured of a quantum communication step in which a sender and a receiver generate their own information sequences, and a post-processing step of adjusting the information sequences to be identical to each other. The quantum cryptography communication process is described below with reference to FIGS. 1 and 2 simultaneously.

First, at the quantum communication step (S10), sender Alice may randomly generate an information sequence. When using light, a first information sequence may be generated by encoding information randomly modulated by phase, polarization, or the like. Sender Alice may transmit the first information sequence to receiver Bob through a wired or wireless communication channel. Receiver Bob generates his own second information sequence based on the received first information sequence. For example, receiver Bob may generate a second information sequence by performing measurement on the first information sequence (by randomly selecting a polarization basis). That is, receiver Bob has an information sequence different from that of sender Alice.

Next, the post-processing step (S20) is a process of adjusting different information sequences of the sender and the receiver to be identical. The post-processing step may include a sifting process, an error correction (Information Reconciliation) process, and a privacy amplification process. The sifting process is a process of leaving only information sequences having the same basis using the basis that is used when the information sequences (first information sequence and second information sequence) of sender Alice and receiver Bob are generated. The error correction process is a process of adjusting the information sequences of sender Alice and receiver Bob, remaining after the sifting process, using an error correction code. The privacy amplification process is a process of removing information, as much as an amount exposed or determined to have been exposed to eavesdropper Eve at the quantum communication step or the post-processing step, from each of the information sequences of sender Alice and receiver Bob remaining after the error correction process is performed. Each information sequence remaining after the privacy amplification process is the encryption key finally distributed to Alice and Bob.

### DISCLOSURE OF INVENTION

### Technical Problem

Therefore, the present invention has been made in view of the above problems, and it is an object of the present invention to provide a quantum cryptography communication method and system, which can reduce the time and cost required for an error correction process and improve security by appropriately determining subjects of encoding and decoding processes needed in the error correction process according to a situation.

The problems to be solved by this embodiment are not limited to the problems described above, and other problems may be inferred from the following embodiments.

### Technical Solution

The time and cost required for an error correction process can be reduced by appropriately determining subjects of encoding and decoding processes needed in the error correction process according to a situation.

### Advantageous Effects

A quantum cryptography communication method and system, which can reduce the time and cost required for an error correction process and improve security by appropriately determining subjects of encoding and decoding processes needed in the error correction process according to a situation, may be disclosed.

### BRIEF DESCRIPTION OF THE DRAWINGS

FIG. 1 is a flowchart illustrating a quantum cryptography communication method according to an embodiment.

FIG. 2 is a view showing a quantum cryptography communication system according to an embodiment.

FIG. 3 is a view showing an information correction process performed in a general mobile communication according to an embodiment.

FIG. 4 is a view showing a first error correction mode according to an embodiment.

FIG. 5 is a view showing a second error correction mode according to an embodiment.

FIG. 6 is a view showing quantum cryptography communication based on a one-way method according to an embodiment.

FIG. 7 is a view showing quantum cryptography communication based on a two-way method according to an embodiment.

FIG. 8 is a view showing quantum cryptography communication between a smartphone and an ATM device according to an embodiment.

FIG. 9 is a view showing a state in which eavesdropper Eve is near Alice according to an embodiment.

FIG. 10 is a view showing a state in which eavesdropper Eve is near Bob according to an embodiment.

FIG. 11 is a view showing signaling information for distinguishing a subject of encoding parity information and a subject of decoding parity information according to an embodiment.

FIG. 12 is a view showing a one-to-many quantum cryptography communication system according to an embodiment.

FIG. 13 is a view showing a process of encoding parity information using default settings without using signaling information according to an embodiment.

FIG. 14 is a view showing a process of decoding parity information using only one bit signaling information according to an embodiment.

FIG. 15 is a view showing a process of decoding parity information by individually designating a subject of decoding parity information using an additional bit according to an embodiment.

FIG. 16 is a view showing a many-to-many quantum cryptography communication system according to an embodiment.

### BEST MODE FOR CARRYING OUT THE INVENTION

To accomplish the above object, according to one aspect of the present invention, there is provided a quantum cryptography communication method performed between at least one first communication device and at least one second communication device by at least one processor, the method comprising: a quantum communication step of generating a second information sequence based on a first information sequence by the second communication device, when the first communication device transmits the first information sequence generated by randomly modulating by a phase or polarization of photons to the second communication device; and a post-processing step of adjusting the first information sequence and the second information sequence to be identical using parity information in an error correction mode selected based on a predetermined criterion, wherein the error correction mode may be one among a first error correction mode in which when the first communication device encodes and transmits first parity information to the second communication device, the second communication device decodes the encoded first parity information to adjust the second information sequence to be identical to the first information sequence, and a second error correction mode in which when the second communication device encodes and transmits second parity information to the first communication device, the first communication device decodes the encoded second parity information to adjust the first information sequence to be identical to the second information sequence, and the predetermined criterion may include a first criterion in which a communication device without a detector placed therein, among the first communication device and the second communication device, performs encoding of the parity information, and a communication device with a detector placed therein, among the first communication device and the second communication device, performs decoding of the parity information, and a second criterion in which any one among the first communication device and the second communication device performs decoding of the parity information on the basis of signaling information including information on a subject of decoding the parity information.

The at least one second communication device may include a plurality of communication devices, and the post-processing step between the first communication device and the plurality of communication devices may be performed according to the first criterion.

The at least one second communication device may include a plurality of communication devices, and the post-processing step between the first communication device and the plurality of communication devices may be performed according to the second criterion.

According to another aspect of the present invention, there is provided a quantum cryptography communication method between at least one first communication device and at least one second communication device performed by at least one processor, the method comprising: a quantum communication step of generating a second information sequence based on a first information sequence by the second communication device, when the first communication device transmits the first information sequence generated by randomly modulating by a phase or polarization of photons to the second communication device; and a post-processing step of adjusting the first information sequence and the second information sequence to be identical using parity information in an error correction mode selected based on a predetermined criterion, wherein the error correction mode may be one among a first error correction mode in which when the first communication device encodes and transmits first parity information to the second communication device, the second communication device decodes the encoded first parity information to adjust the second information sequence to be identical to the first information sequence, and a second error correction mode in which when the second communication device encodes and transmits second parity information to the first communication device, the first communication device decodes the encoded second parity information to adjust the first information sequence to be identical to the second information sequence, and the predetermined criterion may be selecting the first error correction mode as the error correction mode when an eavesdropper is located near the second communication device more than the first communication device, and selecting the second error correction mode as the error correction mode when the eavesdropper is located near the first communication device more than the second communication device.

According to another aspect of the present invention, there is provided a quantum cryptography communication system comprising: a first communication device for transmitting a first information sequence generated by randomly modulating by a phase or polarization of photons to a second communication device; and the second communication device for generating a second information sequence based on the received first information sequence, wherein quantum key distribution may be performed through an error correction process of adjusting the first information sequence and the second information sequence to be identical using parity information in an error correction mode selected based on a predetermined criterion, and the error correction mode may be one among a first error correction mode in which when the first communication device encodes and transmits first parity information to the second communication device, the second communication device decodes the encoded first parity information to adjust the second information sequence to be identical to the first information sequence, and a second error correction mode in which when the second communication device encodes and transmits second parity information to the first communication device, the first communication device decodes the encoded second parity information to adjust the first information sequence to be identical to the second information sequence, and the predetermined criterion may include a first criterion in which a communication device without a detector placed therein, among the first communication device and the second communication device, performs encoding of the parity information, and a communication device with a detector placed therein, among the first communication device and the second communication device, performs decoding of the parity information, and a second criterion in which any one among the first communication device and the second communication device performs decoding of the parity information on the basis of signaling information including information on a subject of decoding the parity information.

According to another aspect of the present invention, there is provided a quantum cryptography communication system comprising: a first communication device for transmitting a first information sequence generated by randomly modulating by a phase or polarization of photons to a second communication device; and the second communication device for generating a second information sequence based on the received first information sequence, wherein quantum key distribution may be performed through an error correction process of adjusting the first information sequence and the second information sequence to be identical using parity information in an error correction mode selected based on a predetermined criterion, and the error correction mode may be one among a first error correction mode in which when the first communication device encodes and transmits first parity information to the second communication device, the second communication device decodes the encoded first parity information to adjust the second information sequence to be identical to the first information sequence, and a second error correction mode in which when the second communication device encodes and transmits second parity information to the first communication device, the first communication device decodes the encoded second parity information to adjust the first information sequence to be identical to the second information sequence, and the predetermined criterion may be selecting the first error correction mode as the error correction mode when an eavesdropper is located near the second communication device more than the first communication device, and selecting the second error correction mode as the error correction mode when the eavesdropper is located near the first communication device more than the second communication device.

Hereinafter, several embodiments will be described clearly and in detail with reference to the accompanying drawings so that those with ordinary knowledge in the technical field to which the present invention pertains (hereinafter, referred to as those skilled in the art) may easily practice the present invention.

Hereinafter, Alice and Bob described above with reference to FIG. 2 are a sender and a receiver of information sequence, respectively. Alice and Bob may represent a first communication device owned by Alice and a second communication device owned by Bob, respectively. The communication devices may include any type of electronic devices that may perform communication, such as phones, computers, laptop computers, mobile devices, server devices, cloud devices, satellite devices, Access Points (APs), home appliances, commercial electronic devices, and the like. For example, Alice may be a smartphone and Bob may be an ATM device.

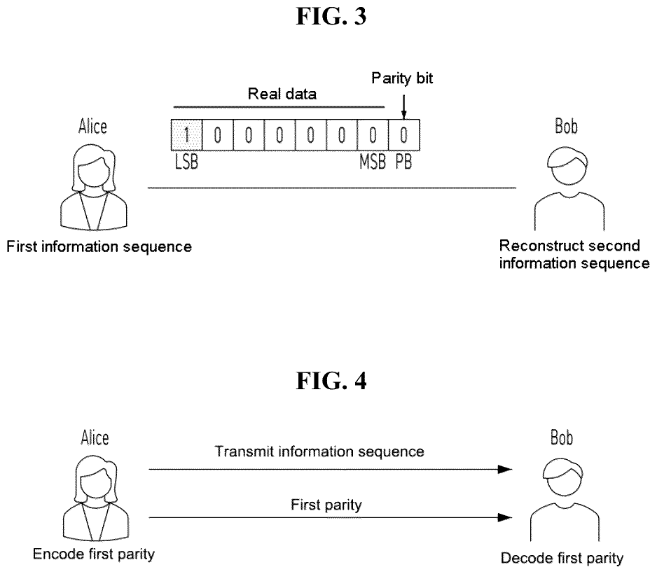

In communication, information correction or error correction means a process of correcting information so that a sender and a receiver may have identical information. FIG. 3 is a view showing an information correction process performed in a general mobile communication according to an embodiment. Referring to FIG. 3, in a general mobile communication, an error correction process is a method in which a sender adds additional information (e.g., a parity bit or syndrome) to an information sequence only the sender knows and transmits the information sequence (actual data) and additional information (e.g., parity bit) through a communication channel, and a receiver reconstructs its own information sequence to be identical to the information sequence that the sender has, using the received information.

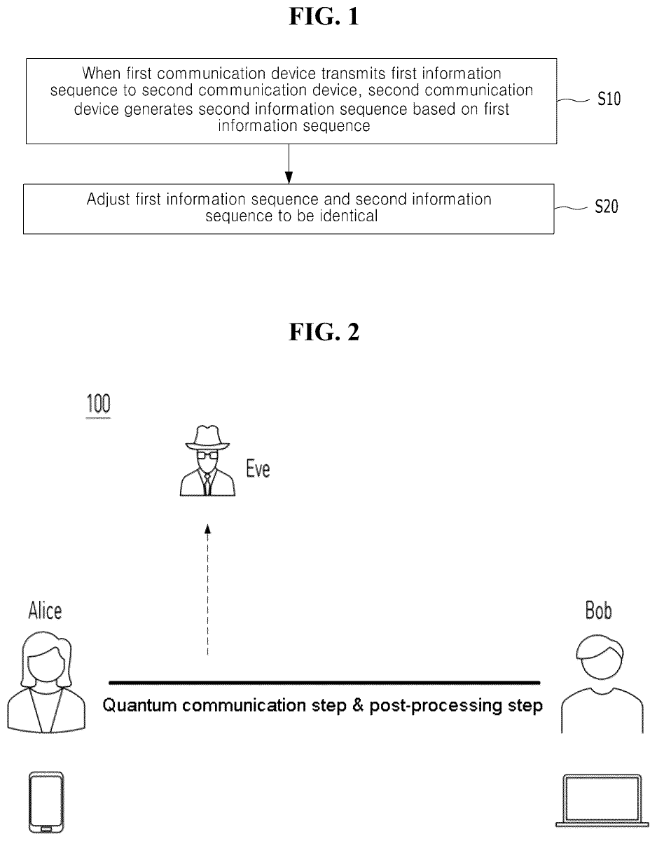

The error correction like this is performed in a quantum cryptography communication system 100 in a similar way. Hereinafter, although the additional information used for error correction is referred to as an “error correction code,” and although “parity information” is described as a representative embodiment of the error correction code, the error correction code is not limited to the parity information. In the quantum cryptography communication system 100, information correction like this may be performed through transmission of additional information (i.e., parity information), in addition to the information sequences (first and second information sequences) that the sender and the receiver have, after the quantum communication step (step S10 in FIG. 1) is completed. That is, unlike a general mobile communication, in quantum cryptography communication, error correction codes are used in the post-processing step after the quantum communication step is completed, and the error correction process may be performed when the sender and the receiver already have their own information sequences. Therefore, the error correction process may be performed under the premise that the communication channel is wiretapped by an eavesdropper. That is, as the communication channel is wiretapped, information transmitted through the communication channel needs to be minimized.

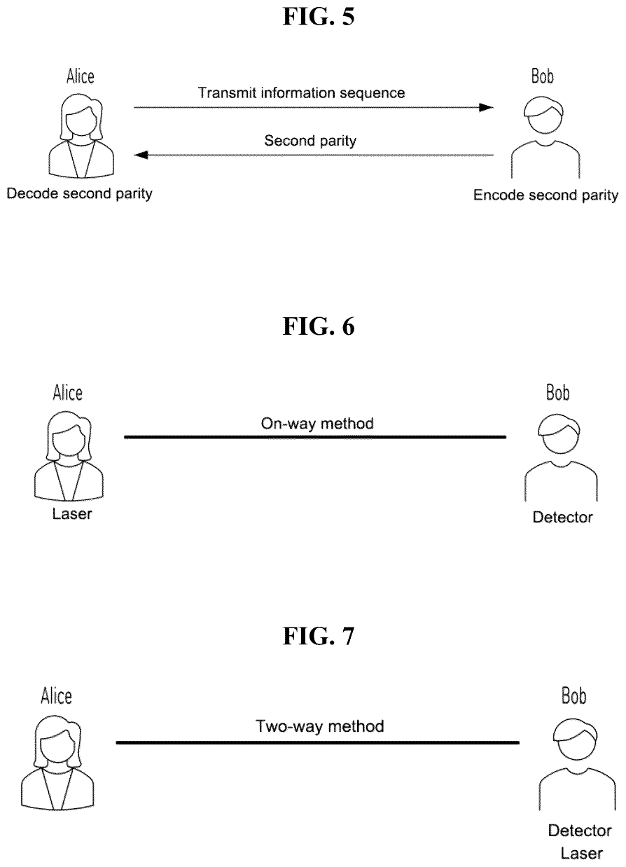

FIG. 4 is a view showing a first error correction mode according to an embodiment, in which Alice performs encoding of parity information, and Bob performs decoding of parity information. FIG. 5 is a view showing a second error correction mode according to an embodiment, in which Bob performs encoding of parity information, and Alice performs decoding of parity information.

The parity information goes through an encoding process performed by a sender and a decoding process performed by a receiver. That is, when a sender of parity information encodes the parity information and transmits the parity information to a counterpart of communication, the counterpart of communication, i.e., receiver of the parity information, may decode the received parity information. Generally, the time required for the decoding process is longer than the time required for the encoding process, and calculation of decoding is more complicated. In a general mobile communication, Alice, the sender of information, performs encoding of parity information, and Bob, the receiver of information, performs decoding of the parity information.

However, in the quantum cryptography communication system 100, sender Alice and receiver Bob already have their own information sequences (after the quantum cryptography step is completed). Therefore, although Alice is the sender of the information sequence and Bob is the receiver of the information sequence at the quantum communication step (S10), apart from this, Alice and Bob may be a receiver or a sender of the parity information, respectively, at the post-processing step (S20).

According to an embodiment, Alice may perform encoding on the parity information and transmit the encoded parity information to Bob through a communication channel, and Bob may adjust the second information sequence to be identical to the first information sequence by performing decoding using the received parity information and the second information sequence that he already has. Bob may transmit a feedback signal about a decoding result or additionally needed information to Alice. This may be referred to as a first error correction mode (see FIG. 4).

According to another embodiment, Bob may perform encoding on the parity information and transmit the encoded parity information to Alice through a communication channel, and Alice may adjust the first information sequence to be identical to the second information sequence by performing decoding using the received parity information and the first information sequence that she already has. Alice may transmit a feedback signal about a decoding result or additionally needed information to Bob. This may be referred to as a second error correction mode (see FIG. 5). Referring to FIGS. 5 and 6, in quantum cryptography communication, sending and receiving parity information after the quantum communication step is completed does not mean that the sender of an information sequence should encode and transmit parity information and the receiver of the information sequence should decode the received parity information.

However, since the parity information transmitted in the first error correction mode is generated based on the first information sequence possessed by Alice, and the parity information transmitted in the second error correction mode is generated based on the second information sequence possessed by Bob, parity information generated according to the error correction mode may vary (the first parity in FIG. 4 and the second parity in FIG. 5 are different from each other).

One of the first error correction mode and the second error correction mode may be determined based on a predetermined criterion, and hereinafter, a predetermined criterion for determining a subject (Alice or Bob) of encoding or decoding the parity information is disclosed.

A first criterion (first standard) is that a subject with a good hardware device performance performs decoding of parity information considering that computational complexity of the decoding process is higher.

In quantum cryptography communication, performing the quantum communication step may be largely divided into a one-way method and a two-way (plug and play) method. Referring to FIG. 6, in the one-way method, a laser for generating photons capable of carrying information may be placed at sender Alice, and a detector for detecting the photons may be placed at receiver Bob. Contrarily, referring to FIG. 7, in the two-way method, a bulky and expensive laser and detector may be simultaneously placed on either sender Alice or receiver Bob (Bob in FIG. 7). According to the first criterion, a subject with superior hardware device performance among Alice and Bob may perform the process of decoding parity information.

The two-way method is used to compensate for change in polarization or shaking of a path, which may occur when quantum keys are distributed through optical fibers although the transmission speed is lowered, and for example, when quantum cryptography communication is performed between a portable terminal, such as a smartphone, and an ATM device of a bank, since the portable terminal is a lightweight device having a limit in memory and performance of a processor, the laser and the detector may be placed in the ATM device.

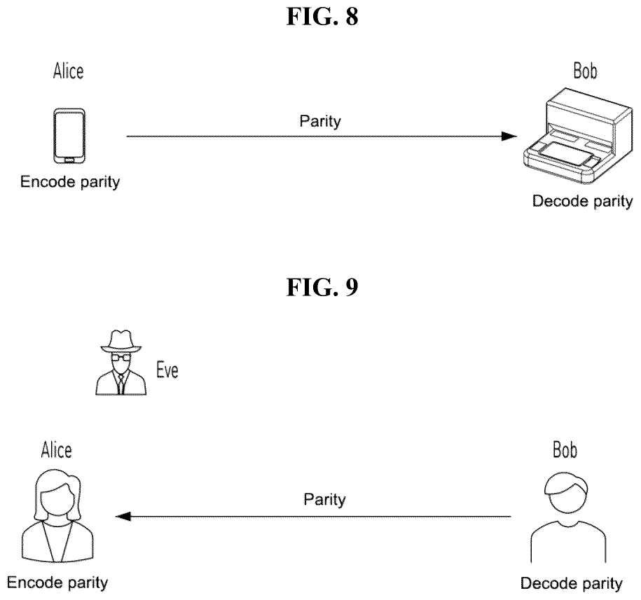

According to an embodiment, a subject where the detector is placed, among Alice and Bob, may be determined to have better hardware device performance. When Alice is a smartphone and Bob is an ATM device where the laser and the detector are placed, decoding of parity information may be performed by Bob and encoding may be performed by Alice (see FIG. 8).

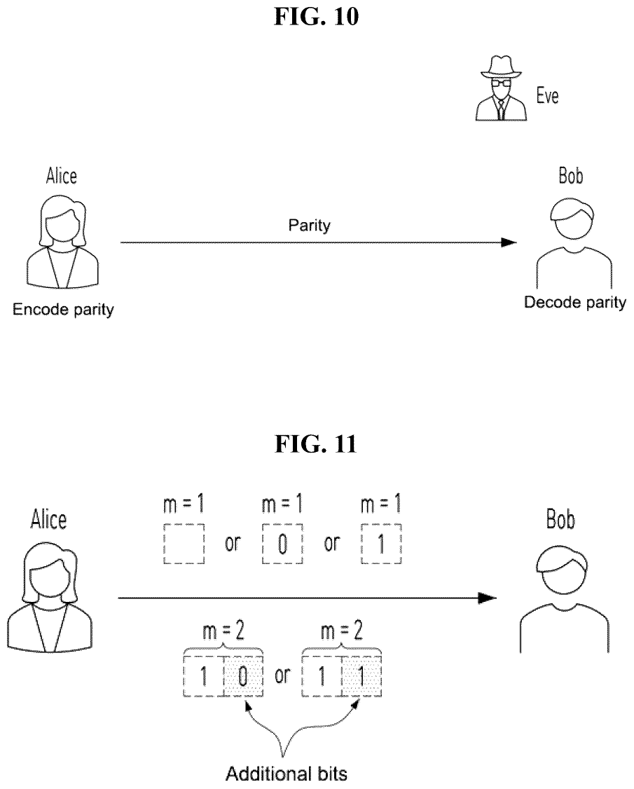

The second criterion (second standard) is that a subject closer to the eavesdropper among Alice and Bob performs decoding of parity information, and the remaining subject performs encoding of parity information. Although it is general that a communication channel (regardless of wired or wireless) has high signal strength near a sender due to transmission loss, a receiver may receive an attenuated signal. When eavesdropper Eve is positioned near either Alice or Bob, eavesdropper Eve may wiretap the parity signal from a nearby subject. When the sender of the parity information is Alice and eavesdropper Eve is near Alice (see FIG. 9), eavesdropper Eve may receive the parity signal more strongly compared to Bob, and there may be more wiretapping information compared to when eavesdropper Eve is near Bob (see FIG. 10). That is, when eavesdropper Eve is near Alice, Bob is determined as the sender of parity information, and thus the amount of eavesdropping information of eavesdropper Eve may be reduced. As a result, it may be determined that a subject relatively near the eavesdropper performs decoding of parity information and a subject far from the eavesdropper performs encoding of parity information.

As an example of the second criterion, a laser and a detector are placed at a ground station considering that it is difficult for a satellite to update equipment or the like in quantum cryptography communication between the ground station and the satellite, and since satellites for eavesdropping may be around a communication target satellite, the ground station may perform encoding of parity information, and the satellite may perform decoding of parity information. In this situation, according to the first criterion, the ground station where the detector is placed should perform decoding of parity information, but according to the second criterion, the satellite may perform decoding of parity information. That is, when the location of the eavesdropper is comparatively clear, the second criterion may take precedence over the first criterion, and when the second standard is applied, it should be taken into account that the location of the eavesdropper may be changed in order to determine a subject that performs decoding of parity information.

The third criterion (third standard) is that the quantum cryptography communication system 100 or the communication subject or operator of the quantum cryptography communication system 100 directly designates a subject of decoding parity information according to a situation. In this embodiment, after a protocol for pre-arranged signaling information is specified, a decoding subject and an encoding subject of the parity information may be determined according to determined signaling information. Such signaling information is more important since the error correction process is not finished with one time of transmission of parity information between Alice and Bob, but transmission of additional parity information may be performed. For example, Alice encodes parity information, and Bob receives and decodes the parity information, and then Bob who is the subject of decoding performs encoding to generate additional parity information, and the additional parity information may be transmitted back to Alice. Alice may decode the received additional parity information. That is, signaling information indicating who will be initially the subject of encoding the parity information may be needed.

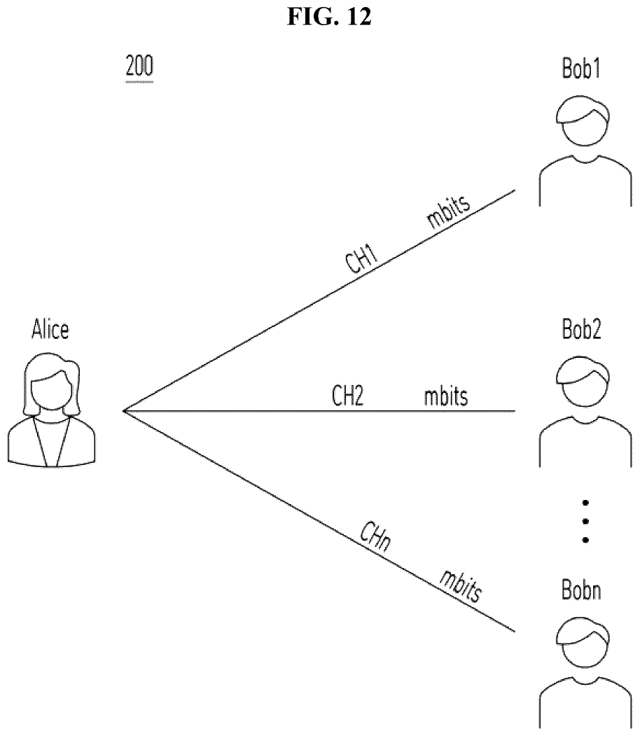

FIG. 11 is a view showing signaling information for distinguishing a subject of encoding parity information and a subject of decoding parity information according to an embodiment.

Signaling information is information for indicating who is the (initial) subject of decoding (or encoding) parity information among the sender and the receiver. When signaling information is not transmitted between Alice and Bob, the subject having the detector may be set to perform decoding of parity information by default (first criterion).

Signaling information may be configured of a sequence of m bits in size (m is an integer). When m is 1, the signaling information may be configured of 1 bit in size, and when m is 2, the signaling information may be configured of 2 bits in size.

When signaling information is transmitted, and the signaling information is ‘0’, decoding of parity information may be performed by a subject that does not have a detector. When the signaling information is ‘1’, a subject for performing decoding of parity information may be individually designated by the quantum cryptography communication system 100. That is, the quantum cryptography communication system 100 may designate either Alice or Bob to perform decoding of parity information, and in this embodiment, the signaling information further includes 1 bit, which is an additional bit, to be a total of 2 bits in size, and a subject who will perform decoding of parity information may be designated accordingly to the signaling information. For example, when the value of the additional bit is ‘0’, Alice may perform decoding of parity information, and when the value of the additional bit is ‘1’, Bob may perform decoding of parity information.

According to an embodiment, signaling information may be configured of 2 bits in size by default. For example, when the signaling information is ‘00’, a subject having a detector may perform decoding of parity information, and when the signaling information is ‘01’, a subject without having a detector may perform decoding of parity information. When the signaling information is ‘10’, it may indicate that both Alice and Bob are capable of encoding or decoding. When the signaling information is ‘11’, a subject initially performing encoding or decoding of the parity information may be designated as one among Alice and Bob.

For example, Alice initially encodes parity information, and Bob receives and decodes the parity information, and then Bob who is the subject of decoding performs encoding to generate additional parity information, and the additional parity information may be transmitted back to Alice. That is, signaling information may be configured of 2 bits assuming a situation in which the error correction process is not finished with one time of transmission of parity information. According to an embodiment, when the upper bit of the signaling information of a 2-bit size has a specific value (for example, 1), it may mean a situation in which the error correction process is not finished with one time of transmission of parity information, and it may be determined which of Alice and Bob will perform encoding or decoding first on the basis of the value of the lower bit.

Signaling information may be transmitted between Alice and Bob in a periodic or aperiodic manner while the quantum cryptography communication method is performed. For example, a corresponding signal may be transmitted unconditionally when quantum key distribution is performed, or may be transmitted periodically according to the number of times of performing the quantum communication step (S10 in FIG. 1), or periodically transmitted for a predetermined period of time.

Those skilled in the art may understand that the size and rules of the signaling information described above may be modified without limit, and numerous embodiments may be generated according to the promise made between Alice and Bob or the protocol of the quantum communication system 100. Therefore, it should be understood that the present invention is not limited to the embodiment described above with reference to FIG. 11. In addition, the embodiment described above with reference to FIG. 11 relates to a one-to-one quantum cryptography communication system, and this may be equally applied to a one-to-many, many-to-one, or many-to-many quantum cryptography communication system.

FIG. 12 is a view showing a one-to-many quantum cryptography communication system according to an embodiment. One-to-many quantum cryptography communication is a method in which one sender (Alice) communicates with multiple receivers (Bob₁, Bob₂, . . . , Bob_{N}) (N is a positive integer).

The one-to-many quantum cryptography communication system 200 may be configured of one-to-one quantum cryptography communication between Alice and Bob₁, one-to-one quantum cryptography communication between Alice and Bob₂, . . . , and one-to-one quantum cryptography communication between Alice and BobN. That is, the one-to-many quantum cryptography communication system 200 may be configured of a plurality of one-to-one quantum cryptography communications.

In the one-to-many quantum cryptography communication system 200, bits of an m*N size may be used as signaling information representing the subject of decoding parity information. m bits are the size of signaling information in one-to-one communication, and N is the number of one-to-one quantum cryptography communications. That is, as the one-to-many quantum cryptography communication system 200 is configured of one-to-one quantum cryptography communication between Alice and Bob₁ performed through a communication channel (CH1), one-to-one quantum cryptography communication between Alice and Bob₂ performed through a communication channel (CH2), . . . , and one-to-one quantum cryptography communication between Alice and Boby performed through a communication channel (CHN), details of the signaling information described above with reference to FIG. 11 may be equally applied to each of the one-to-one quantum cryptography communications through a communication channel.

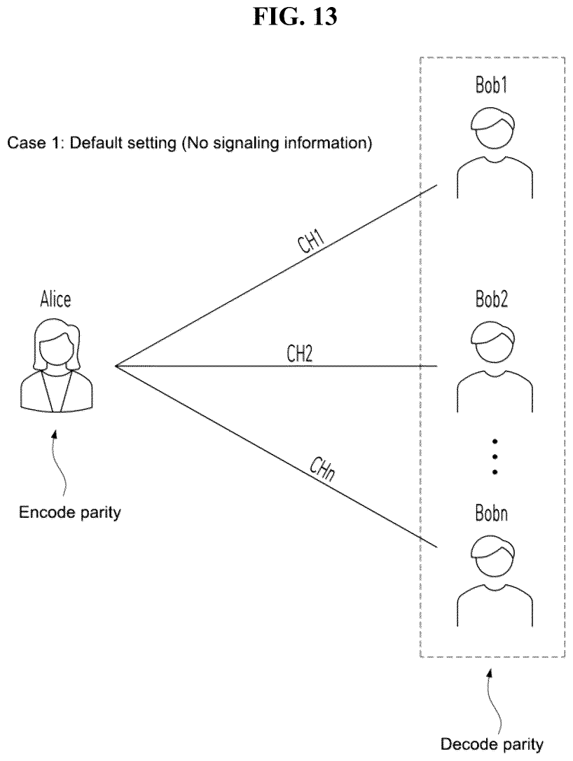

According to an embodiment, all or at least some subjects participating in the one-to-many quantum cryptography communication may be set to use default settings (i.e., a subject having a detector performs decoding of parity information) without using signaling information in order to reduce the amounts of bits transmitted as signaling information. FIG. 13 is a view showing a process of encoding parity information using default settings without using signaling information according to an embodiment (it is assumed that a detector is placed in each of the receivers (Bob₁, Bob₂, . . . , Bob_{N})).

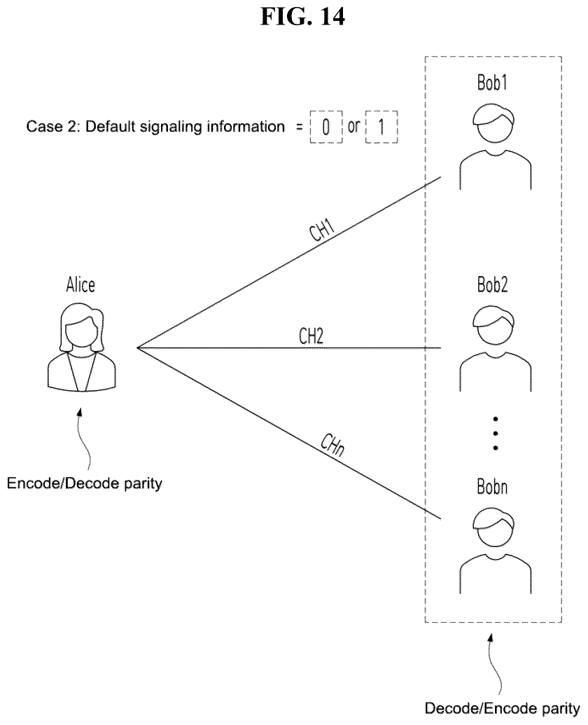

The criteria for determining a subject of decoding parity information in the entire one-to-many quantum cryptography communication system 200 may be unified. In this embodiment, a subject that will perform decoding of parity information may be determined with only one bit, instead of using m*N bits. According to an embodiment, in the entire one-to-many quantum cryptography communication system 200, signaling information is configured of only 1 bit in size, and any one among sender Alice and the receiver group (Bob₂, . . . , Bob_{N}) may be determined as the subject of decoding parity information. For example, when the signaling information is ‘0’, sender Alice may perform encoding, and the receiver group (Bob₁, Bob₂, . . . , BobN) may perform decoding. When the signaling information is ‘1’, sender Alice may perform decoding, and the receiver group (Bob₁, Bob₂, . . . , Bob_{N}) may perform encoding. FIG. 14 is a view showing a process of decoding parity information using only one bit signaling information according to an embodiment. According to an embodiment, although the signaling information is configured of 2 bits in size, a bit value indicating that the criteria for determining a subject of decoding parity information are unified is located in the upper bit, and a bit value specifying a subject of decoding parity information is located in the lower bit, this is not limited as it can be configured freely.

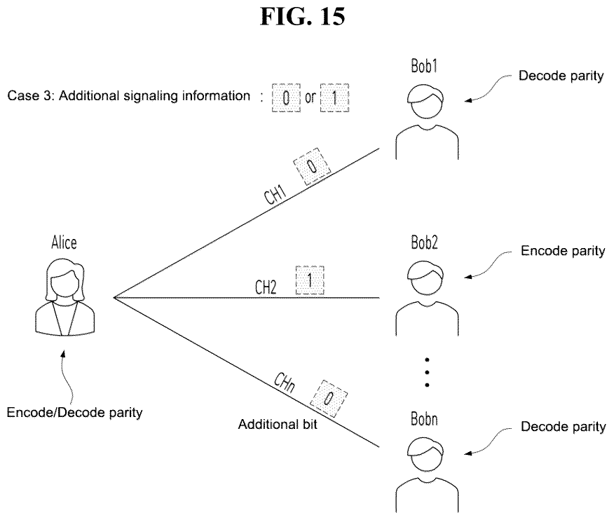

According to an embodiment, some of the one-to-one communications constituting the one-to-many quantum cryptography communication system 200 may unify the criteria for determining a subject of decoding parity information, and the rest may individually designate a subject of decoding parity information. Signaling information may further require an additional bit to individually designate a subject of decoding parity information. FIG. 15 is a view showing a process of decoding parity information by individually designating a subject of decoding parity information using an additional bit according to an embodiment. When an additional bit is used, the size of signaling information increases.

Many-to-one quantum cryptography communication is a method in which multiple senders (Alice₁, Alice₂, . . . , Alice_{N}) communicate with one receiver (Bob) (N is a positive integer). Since the many-to-one quantum cryptography communication has a structure reversed to the one-to-many quantum cryptography communication, those described above in relation to the one-to-many quantum cryptography communication may be equally applied to the many-to-one quantum cryptography communication, and detailed description thereof will be omitted.

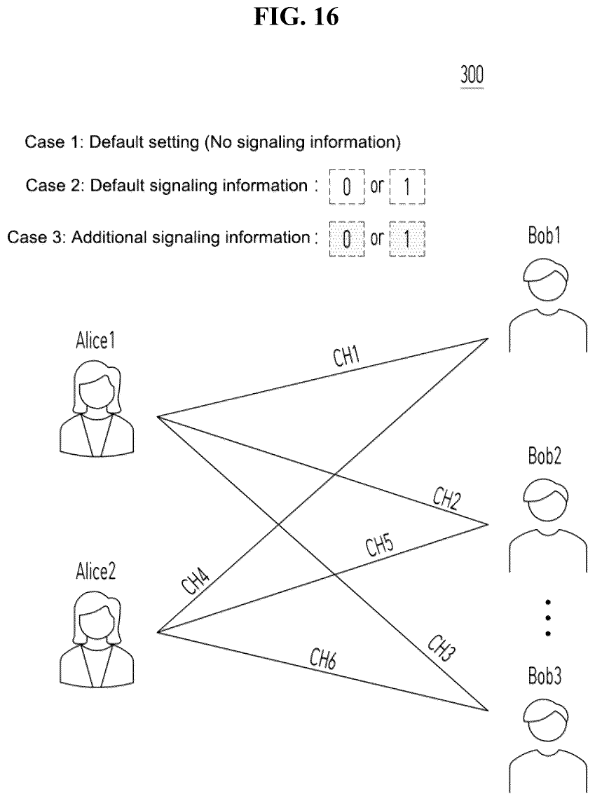

FIG. 16 is a view showing a many-to-many quantum cryptography communication system according to an embodiment.

Many-to-many quantum cryptography communication is a method in which multiple senders (Alice₁, Alice₂, . . . , Alice_{N}) communicate with multiple receivers (Bob₁, Bob₂, . . . , Bob_{K}) (N and K are positive integers). For example, the many-to-many quantum cryptography communication system 300 may be configured of one-to-one communication between Alice₁ and Bob₁, one-to-one communication between Alice₁ and Bob₂, one-to-one communication between Alice₁ and Bob_{K}, one-to-one communication between Alice₂ and Bob₁, one-to-one communication between Alice₂ and Bob₂, and one-to-one communication between Alice₂ and Bob_{K}. That is, the many-to-many quantum cryptography communication system 300 may be configured of N*K one-to-one quantum cryptography communications.

Details of the signaling information described above with reference to FIG. 11 may be equally applied to each of the one-to-one quantum cryptography communications through a communication channel. In the many-to-many quantum cryptography communication system 300, signaling information indicating a subject of decoding parity information may be expressed in a size of m*N*K bits. m bits are the size of signaling information in one-to-one communication.

According to an embodiment, all or some of subjects participating in the many-to-many quantum cryptography communication system 300 may be set to use default settings (i.e., a subject having a detector performs decoding of parity information) without using signaling information.

According to an embodiment, the criteria for determining a subject of decoding parity information for the entire many-to-many quantum cryptography communication system 300 may be unified. Alternatively, in the many-to-many quantum cryptography communication system 300, senders may be divided into groups (for example, a first communication group between Alice₁ and receivers (Bob₁, Bob₂, . . . , Bob_{K}) and a second communication group between Alice₂ and receivers (Bob₁, Bob₂, . . . , Bob_{K})), and a different criterion for determining a subject of decoding parity information may be applied to each group, and a unified criterion may be used in one group. Alternatively, in the many-to-many quantum cryptography communication system 300, receivers may be divided into groups (for example, a first communication group between Bobi and senders (Alice₁, Alice₂), a second communication group between Bob₂ and senders (Alice₁, Alice₂), and a third communication group between Bob₃ and senders (Alice₁, Alice₂)), and a different criterion for determining a subject of decoding parity information may be applied to each group, and a unified criterion may be used in one group.

According to an embodiment, some of the one-to-one communications constituting the many-to-many quantum cryptography communication system 300 may unify the criteria for determining a subject of decoding parity information, and the rest may individually designate a subject of decoding parity information. Signaling information may further require an additional bit for specifying a subject of decoding in order to individually designate a subject of decoding parity information.

According to an embodiment, the signaling information described above may be transmitted between a sender and a receiver using a method such as a physical downlink control channel (PDCCH) such as 5G, LTE-A, LTE, Wi-Fi, or the like, an Enhanced Physical Downlink Control Channel (Enhanced PDCCH), a Physical Downlink Shared Channel (PDSCH), Cell-specific high-layer signaling, UE-specific high-layer signaling, or the like.

According to an embodiment, signaling information may be part of information in the distributed quantum key. For example, signaling information may be included in the second information sequence generated by Bob after step S10 of FIG. 1, but it is not limited thereto.

The descriptions are intended to provide exemplar configurations and operations for implementing the present invention. The technical spirit of the present invention will include implementations that can be obtained by simply changing or modifying the above embodiments, in addition to the embodiments described above. In addition, the technical spirit of the present invention will also include implementations that can be easily achieved by changing or modifying the embodiments described above.

1. A quantum cryptography communication method performed between at least one first communication device and at least one second communication device by at least one processor, the method comprising:
a quantum communication step of generating a second information sequence based on a first information sequence by the second communication device, when the first communication device transmits the first information sequence generated by randomly modulating by a phase or polarization of photons to the second communication device; and
a post-processing step of adjusting the first information sequence and the second information sequence to be identical using parity information in an error correction mode selected based on a predetermined criterion, wherein
the error correction mode is one among a first error correction mode in which when the first communication device encodes and transmits first parity information to the second communication device, the second communication device decodes the encoded first parity information to adjust the second information sequence to be identical to the first information sequence, and a second error correction mode in which when the second communication device encodes and transmits second parity information to the first communication device, the first communication device decodes the encoded second parity information to adjust the first information sequence to be identical to the second information sequence, and
the predetermined criterion includes a first criterion in which a communication device without a detector placed therein, among the first communication device and the second communication device, performs encoding of the parity information, and a communication device with a detector placed therein, among the first communication device and the second communication device, performs decoding of the parity information, and a second criterion in which any one among the first communication device and the second communication device performs decoding of the parity information on the basis of signaling information including information on a subject of decoding the parity information.

2. The method according to claim 1, wherein the at least one second communication device includes a plurality of communication devices, and the post-processing step between the first communication device and the plurality of communication devices is performed according to the first criterion.

3. The method according to claim 1, wherein the at least one second communication device includes a plurality of communication devices, and the post-processing step between the first communication device and the plurality of communication devices is performed according to the second criterion.

4. A quantum cryptography communication method between at least one first communication device and at least one second communication device performed by at least one processor, the method comprising:
a quantum communication step of generating a second information sequence based on a first information sequence by the second communication device, when the first communication device transmits the first information sequence generated by randomly modulating by a phase or polarization of photons to the second communication device; and
a post-processing step of adjusting the first information sequence and the second information sequence to be identical using parity information in an error correction mode selected based on a predetermined criterion, wherein
the error correction mode is one among a first error correction mode in which when the first communication device encodes and transmits first parity information to the second communication device, the second communication device decodes the encoded first parity information to adjust the second information sequence to be identical to the first information sequence, and a second error correction mode in which when the second communication device encodes and transmits second parity information to the first communication device, the first communication device decodes the encoded second parity information to adjust the first information sequence to be identical to the second information sequence, and
the predetermined criterion is selecting the first error correction mode as the error correction mode when an eavesdropper is located near the second communication device more than the first communication device, and selecting the second error correction mode as the error correction mode when the eavesdropper is located near the first communication device more than the second communication device.

5. A quantum cryptography communication system comprising:
a first communication device for transmitting a first information sequence generated by randomly modulating by a phase or polarization of photons to a second communication device; and
the second communication device for generating a second information sequence based on the received first information sequence, wherein
quantum key distribution is performed through an error correction process of adjusting the first information sequence and the second information sequence to be identical using parity information in an error correction mode selected based on a predetermined criterion, and
the error correction mode is one among a first error correction mode in which when the first communication device encodes and transmits first parity information to the second communication device, the second communication device decodes the encoded first parity information to adjust the second information sequence to be identical to the first information sequence, and a second error correction mode in which when the second communication device encodes and transmits second parity information to the first communication device, the first communication device decodes the encoded second parity information to adjust the first information sequence to be identical to the second information sequence, and
the predetermined criterion is characterized by either (a) or (b):
(a) the predetermined criterion includes a first criterion in which a communication device without a detector placed therein, among the first communication device and the second communication device, performs encoding of the parity information, and a communication device with a detector placed therein, among the first communication device and the second communication device, performs decoding of the parity information, and a second criterion in which any one among the first communication device and the second communication device performs decoding of the parity information on the basis of signaling information including information on a subject of decoding the parity information,
(b) the predetermined criterion is selecting the first error correction mode as the error correction mode when an eavesdropper is located near the second communication device more than the first communication device, and selecting the second error correction mode as the error correction mode when the eavesdropper is located near the first communication device more than the second communication device.

6. (canceled)
